(19) United States
(12) Patent Application Publication
(10) Pub. No.: US 2006/0054458 A1
(43) Pub. Date: Mar. 16, 2006

(54) Stepchain link for an escalator

(75) Inventors: Helmut J W Meyer, Buckeburg (DE); Richard N. Fargo, Plainville, CT (US)

Correspondence Address: Karin H Butchko;Carlson Gaskey & Olds, Suite 350, 400 West Maple Road, Birmingham, MI, 48009, US

(73) Assignee: OTIS ELECATOR COMPANY, FAR,OPMGTPM (DE)

(21) Appl. No.: 10/532,997

(22) PCT Filed: Dec. 13, 2002
(86) PCT No.: PCT/US02/39945

§ 371 Date: Apr. 28, 2005

(51) Int. Cl. B66B 23/02

(52) U.S. Cl. 198/330

(57) ABSTRACT

A plurality of stepchain links (30, 130, 230) of a passenger conveyor system (20) connected to form a continuous loop are from die cast or from stamped or laser cut metal. Each stepchain link (30, 130, 230) includes a plurality of teeth (32, 132, 232) made of a single piece of material that engage a drive member (36). In one example, a plate of injection molded plastic teeth (294) are snapped onto the links to reduce corrosion.

### BACKGROUND OF THE INVENTION

This invention generally relates to passenger conveyor systems. More particularly, this invention relates to a stepchain link for a passenger conveyor which has a plurality of teeth that are made of an integrated single piece of material.

Conventional passenger conveyors, such as escalators or moving walkways, include a chain of steps that travel in a loop to provide a continuous movement along a specified path. The steps are connected to a continuous loop of stepchain links that include a plurality of teeth that interact with a drive mechanism. As the stepchain links move, the steps move as desired.

In prior modular-drive passenger conveyor systems, the stepchain links each are made of a plurality of laminated stacked steel sheets each including holes. When the plurality of laminated steel sheets are stacked, the holes are aligned and receive a rivet, securing the laminated, stacked steel sheets together to form a stepchain link.

A drawback to the conventional laminated, stacked steel sheet stepchain links is that the stepchain links are heavy. The prior art stepchain links commonly have a width of 30 mm, which is less than desirable for some applications.

The prior art drive chains are made of steel plates and sheets and connected by pin. The stepchain links that cooperate with the drive chain are made of a teethed or cogged laminated stacked steel sheets. As both the stepchain links and the drive chains are steel, lubrication is required. Lubrication also is required at the connection between each of the stepchain links. One drawback to providing lubrication is that lubrication is messy. Another drawback is the need for increased maintenance to replenish the lubrication, for example, and the cleaning of old lubricant.

Hence, there is a need in the art for an arrangement that does not suffer from the weight and lubrication drawbacks and shortcomings of the prior art. This invention includes a stepchain link which has a plurality of teeth that are made of an integrated single piece of material, which does not require lubrication and avoids the other mentioned problems associated with prior designs.

### SUMMARY OF THE INVENTION

In general terms this invention is a passenger conveyor system that includes a plurality of stepchain links having a unique configuration that facilitates interaction between the chain and a drive mechanism. The inventive links include a plurality of teeth that are made of an integrated single piece of material.

In one example, the stepchain links are made of die cast metal. When attached, each stepchain link includes a first end that is received between two spaced apart portions in a second end of another stepchain link. The first end and the second end of the stepchain links have holes that are aligned when assembled. An attachment mechanism is inserted in the aligned holes to secure the stepchain links together. In one example, each stepchain link includes a bridge support to support a bridge positioned between the disc members of adjacent steps.

A second example stepchain link is made of steel. The steel can be stamped steel or laser cut steel. Each stepchain link includes two inner portions having a plurality of inner holes. The ends of the inner portions are secured to the ends of another two inner portions by an attachment mechanism. The two inner portions of each link are positioned in an outer portion including a first side, a second side, and a bottom having a plurality of teeth. The first side and the second side have a plurality of outer holes that align with the inner holes of the two inner portions. An attachment member extends through the aligned holes to secure the two inner portions to the outer portion. In one example, the attachment members have a square cross section and are interference fit into correspondingly shaped attachment holes. The two inner portions bear the tensile load of the chain, and the outer portion engages the drive member.

In another example embodiment, a plate of injection molded plastic teeth are snapped onto the bottom edge of the two secured inner portions. The plastic teeth engage the drive member.

These and other features of the present invention will be best understood from the following specification and drawings.

### BRIEF DESCRIPTION OF THE DRAWINGS

FIG. 1 schematically illustrates selected portions of a passenger conveyor system;

FIG. 2 schematically illustrates selected portions of an example drive assembly designed according to the present invention;

FIG. 3 schematically illustrates a step of the passenger conveyor system;

FIG. 4 schematically illustrates an axle and two example stepchain links;

FIG. 5 schematically illustrates, in perspective view, a first example stepchain link;

FIG. 6 schematically illustrates, in perspective view, two first example stepchain links attached;

FIG. 7 schematically illustrates a top view of the area encircled 7 in FIG. 6;

FIG. 8A schematically illustrates a perspective view of the assembly of the inner portions of two of a second example stepchain links;

FIG. 8B schematically illustrates a perspective view of the attachment of the inner portions of two of a second example stepchain links;

FIG. 8C schematically illustrates a perspective view of the attachment of the outer portion to the second example stepchain links;

FIG. 8D schematically illustrates a perspective view of the attachment of the bridge to the two second example stepchain links;

FIG. 8E schematically illustrates a perspective view of the second example stepchain links after rotation of the pins and the axle;

FIG. 9 schematically illustrates an example outer portion of the second example stepchain link;

FIG. 10 schematically illustrates a cross-sectional view taken along the line 10-10 in FIG. 8D;

FIG. 11 schematically illustrates an end of the outer portion of the second example and an attachment member;

FIG. 12A schematically illustrates a top view of an example attachment member;

FIG. 12B schematically illustrates an end view of the example attachment member of FIG. 12A taken along line 12B-12B;

FIG. 13 schematically illustrates another example outer portion of a link including injection molded teeth; and

FIG. 14 schematically illustrates a rear view of the bridge supported by the stepchain links of the present invention.

### DETAILED DESCRIPTION OF THE PREFERRED EMBODIMENTS

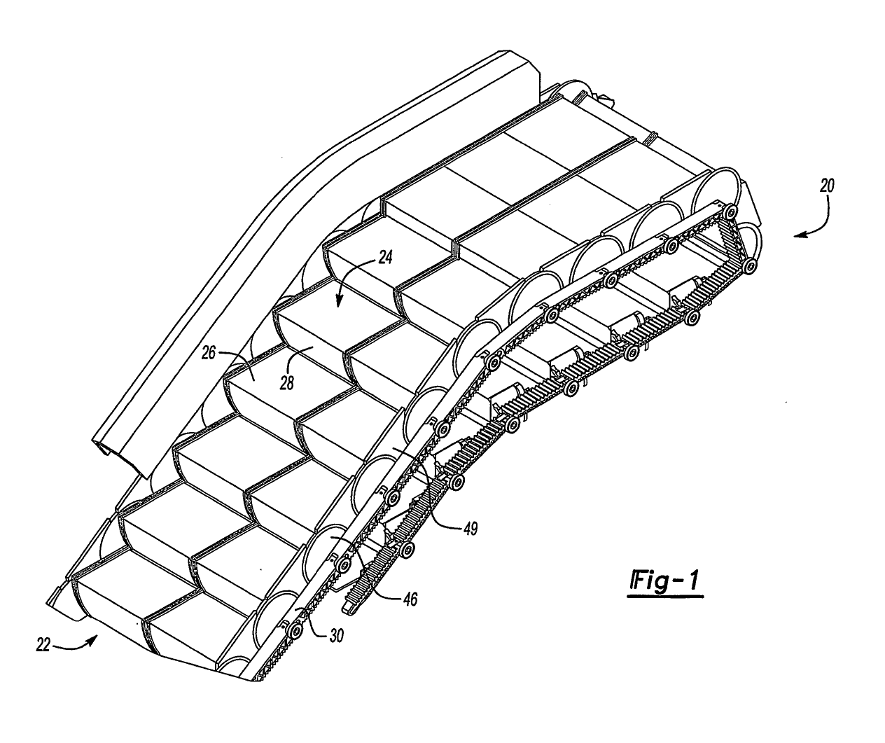

FIG. 1 schematically illustrates a passenger conveyor system 20. This example shows an escalator, but this invention is not so limited. Other conveyors are within the scope of this invention, such as moving walkways. This passenger conveyor system 20 includes steps 24 configured to travel in a loop and having a tread surface 26 and a rise surface 28. A drive assembly 28 moves the plurality of steps 24 in a desired direction. The opposing ends of each step 24 include a disc member 46. A bridge 49 is positioned between the disc members 46 of adjacent steps 24 to close the gap between the disc members 46.

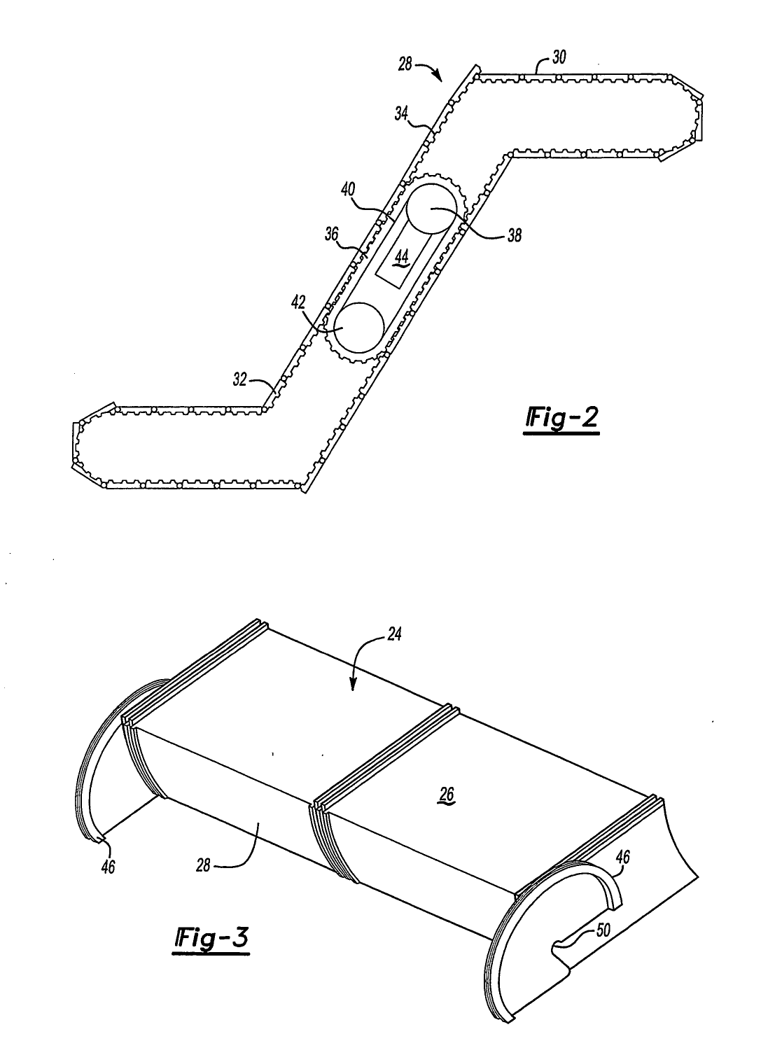

As shown in FIG. 2, the drive assembly 28 includes a plurality of stepchain links 30 which form a continuous loop. The stepchain links 30 have a plurality of teeth 32 that engage an outer surface 34 of a drive member 36. Preferably, the outer surface 34 of the drive member 36 has a profile that corresponds to the profile of the plurality of teeth 32. In one example, each tooth 32 has a height of 5 mm and a pitch of 20 mm.

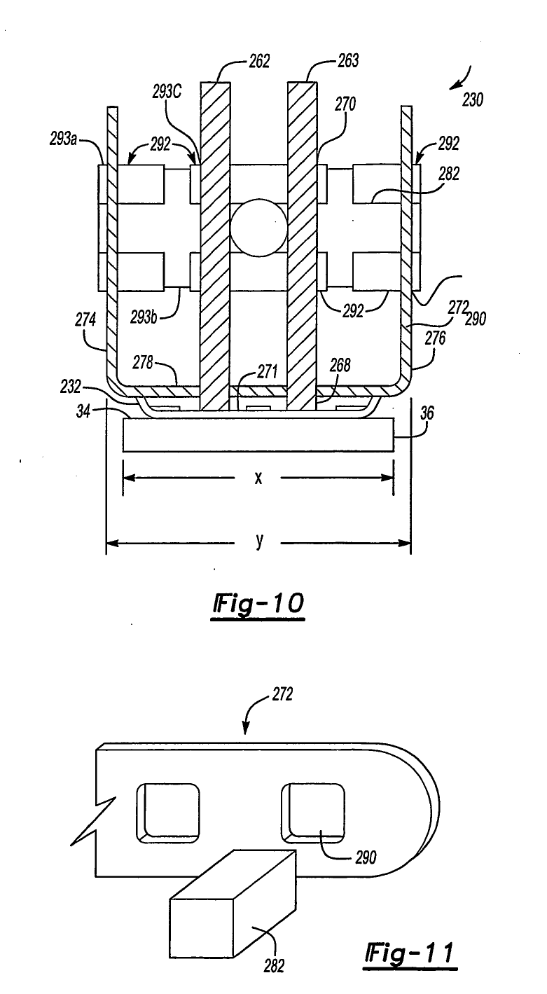

The drive member 36 in one example preferably has a width X of 65 mm wide and the stepchain links 30 preferably have a width Y of 70 mm (shown in FIG. 10). The drive member 36 in one example is a belt that is formed of polyurethane and includes a plurality of cords. In this example, the plurality of cords made of steel or Kevlar and are the tensile carrying portion of the drive member 36. The drive member 36 is formed by placing the cords in a two piece mold. Polyurethane is introduced into the mold, integrating the plurality of cords within the polyurethane. In such an arrangement, as the drive member 36 is polyurethane, lubrication is not needed between the stepchain links 30 and the drive member 36 as there is no metal-to-metal engagement. In another example, the drive member 36 is a drive chain.

A drive sheave 38 engages an inner surface 40 and the plurality of cords of the drive member 36 to move the drive member 36 around a loop. An idle sheave 42 is positioned at an opposite end of the loop from the drive sheave 38. A drive mechanism 44 is schematically shown for moving the drive sheave 38 in the desired direction and at the desired speed. The drive mechanism 44 includes a motor and a braking mechanism as known in the art, for example. Preferably, the passenger conveyor system 20 includes two drive members 36 running in parallel at the lateral edges of the steps 24 and two sets of continuous stepchain links 30. Each set of continuous stepchain links 30 cooperates with one of the drive members 36.

Teeth 32 on the stepchain links 30 engage the outer surface 34 of the drive member 36 so that the steps 24 move responsive to the drive mechanism 44. Various tooth 32 profiles may be used, depending on the particular arrangement. In the present invention, the teeth 32 are made of an integrated single piece of material.

As shown in FIG. 3, each step 24 includes a disc member 46 adjacent each side edge of the step 24. The disc members 46 prevent objects from getting caught along the edges of the passenger conveyor system 20 during operation and moves with the steps 24.

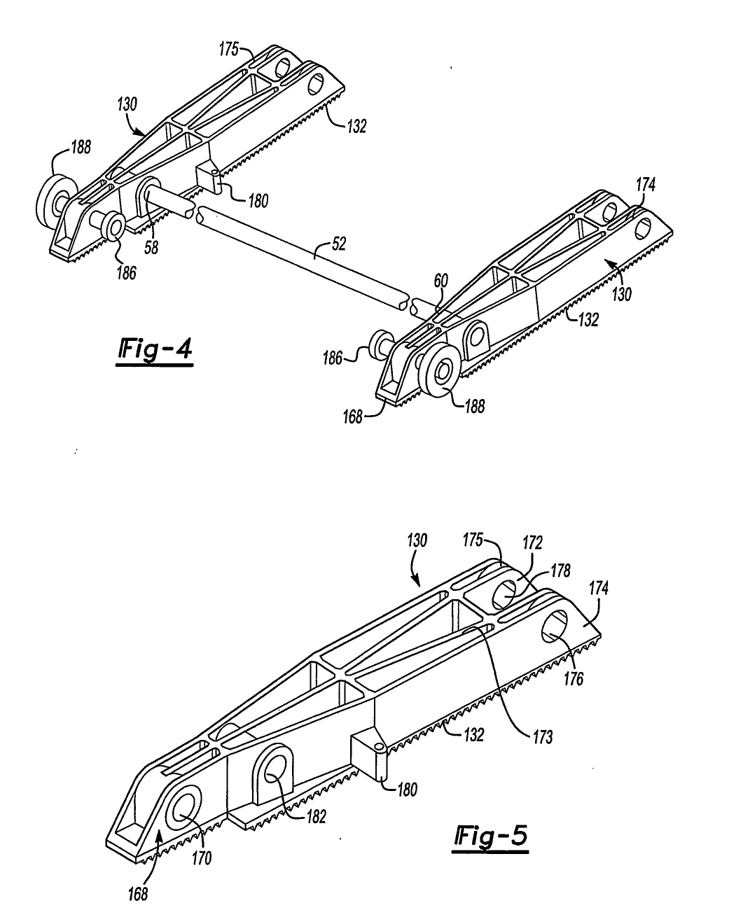

As shown in FIG. 4, the ends 58 and 60 of the axle 52 are attached to a corresponding stepchain link 30. The cap 186 is attached by the hub portion 50 of the disc members 46 such that the stepchain links 30 are positioned outwardly of the disc members 46.

FIG. 5 illustrates a first example stepchain link 130 made of die cast metal, such as aluminum or magnesium. The stepchain link 130 includes a plurality of teeth 132, a first end 168 having a hole 170, and a second end 172 with two spaced portions 174 and 175 each having a hole 176 and 178, respectively. The axle 52 is press-fit into a hole 182 in the stepchain link 130.

Each stepchain link 130 further includes a bridge support 180 which supports the bridge 49 positioned between the disc members 46 of adjacent steps 24 during operation of the conveyor system 20 (further shown in FIG. 1). The bridge 49, as further shown in FIG. 14, is preferably made of aluminum. The bridge 49 is substantially v-shaped and includes an enlarged upper end 55 and a smaller lower end 57. Sides 59 extend from the upper end 55 to the lower end 57. Each bridge 49 includes a pin 51 on the lower end 57 which is received in the bridge support 180, securing the bridge 49 to the stepchain link 130.

The link 130 further includes a webbed portion 173 which carries the tensile forces when the plurality of stepchain links 130 are in tension. The webbed portion 173 prevents bending and transfers tensile forces from the spaced portions 174 and 175 to the first end 168.

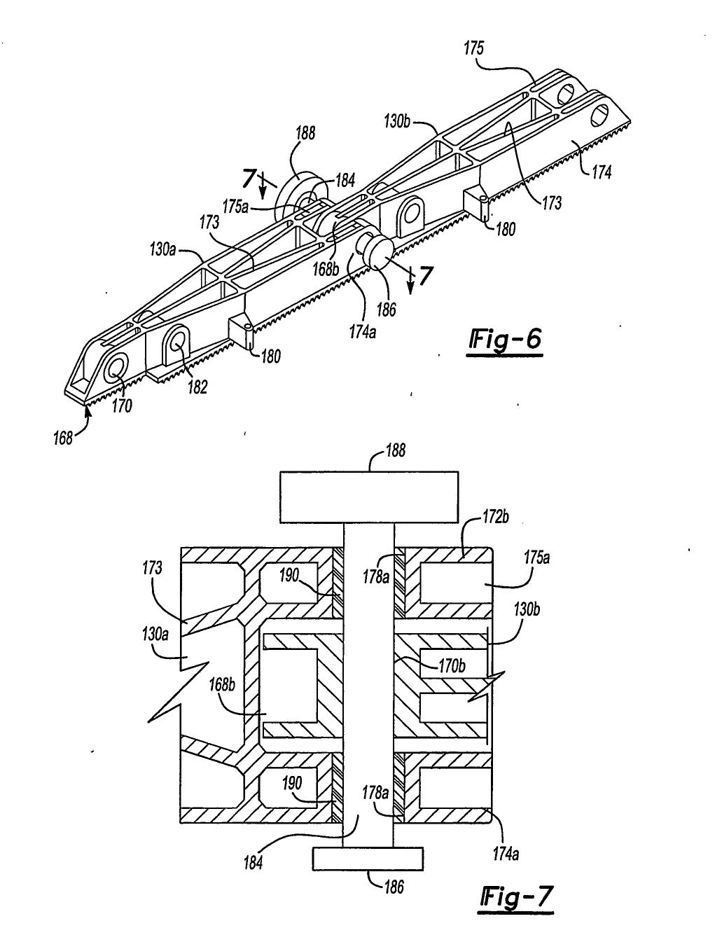

FIG. 6 illustrates an example pair of stepchain links 130a and 130b. The first end 168b of the stepchain link 130b is inserted between the two spaced apart portions 174a and 175a of stepchain link 120a. As shown in FIG. 7, the holes 170b, 176a and 178a are aligned and receive an attachment member 184, securing the stepchain links 130a and 130b together. A cap 186 and a stepchain roller 188 are attached to the opposing ends of the attachment member 184. The shouldered attachment member 184 secures the stepchain links 130a and 130b and is press fit in the hole 170b, fixing the distance between the wheel 64 and the cap 186.

As further shown in FIG. 7, needle bearings 190 are positioned between the attachment member 184 and the holes 176a and 178a, eliminating the need for lubrication. The needle bearings 190 rotate around the attachment member 184. The lubrication is sealed in the bearings 190 during assembly, eliminating the need to lubricate the bearing 190 during use. Although only two stepchain links 130a and 130b are illustrated and described, it is to be understood that a plurality of stepchain links 130 are employed to create a continuous loop.

Although the stepchain links 130a and 130b have been described as having a first end 168 and a second end 172 with two spaced portions 174 and 175, it is to be understood that stepchain links 130a can include two first ends 168a and stepchain links 130b can include two second ends 172b having two spaced apart portions 174b and 175b. The stepchain links 130a and 130b are assembled in an alternating pattern to create a continuous loop.

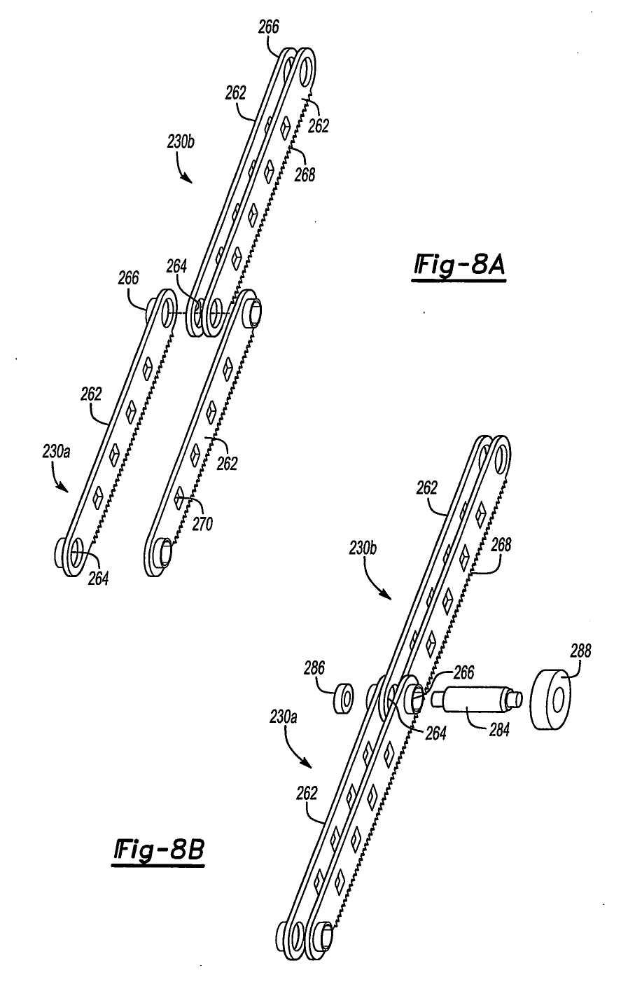

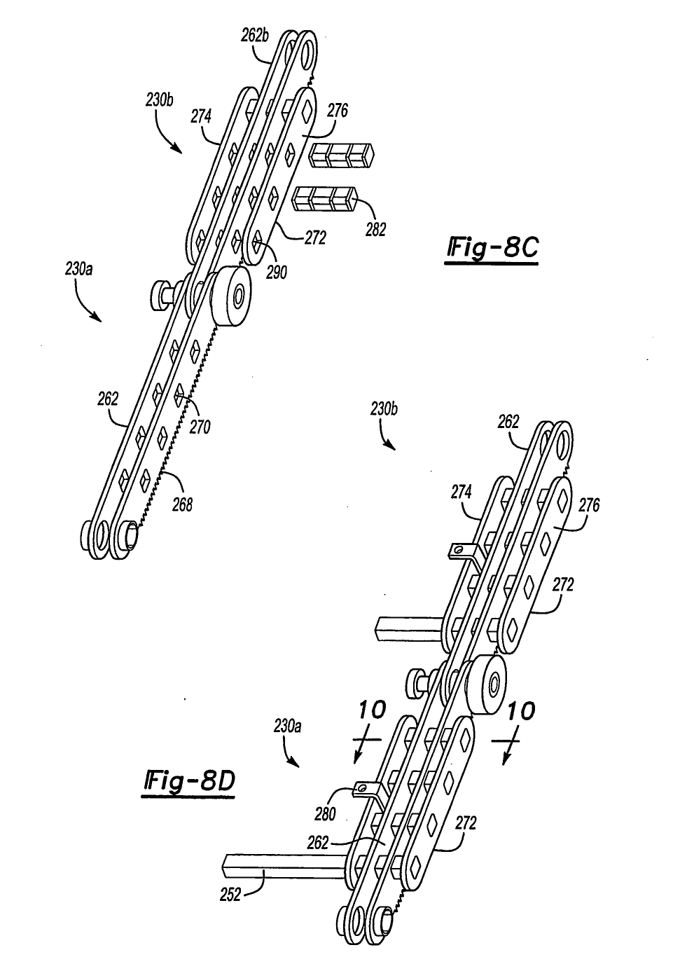

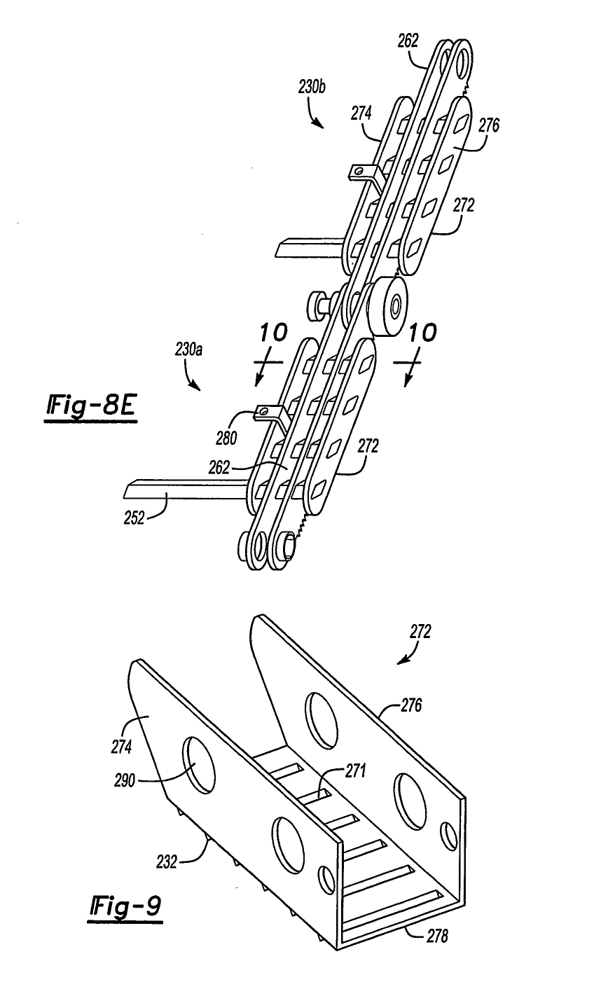

In another example, the stepchain links 230 are made of sheet metal portions, as shown in FIGS. 8A to 10. In one example, steel is the preferred material. The steel can be stamped or laser cut. FIGS. 8A to 8D show two links 230a and 230b at various stages of assembly.

Each stepchain link 230a and 230b in this example includes two inner portions 262. The inner portions 262 of the stepchain link 230b are spaced close together. The inner portions 262 of the stepchain link 230a are spaced farther apart and are outside of the inner portions 262 of the stepchain link 230b. Each inner portion has a first hole 264 near one end a second hole 266 at an opposite end. The inner portions 262 include a plurality of inner teeth 268 and a plurality of attachment holes 270. Although FIG. 8A illustrates four attachment holes 270 on each inner portion 262, it is to be understood that any number of attachment holes 270 can be employed.

The inner portions 262 are assembled in an alternating manner such that both the first holes 264 and the second holes 266 of a first stepchain link 230a are located outwardly of the first holes 264 and second holes 266 of the adjacent stepchain links 230b. That is, the second holes 266 of the inner portions 262 of a first stepchain link 230a are positioned outwardly of the first holes 264 of the inner portions 262 of a second stepchain links 230b. The second holes 266 of the inner portions 262 of the second stepchain link 230b are positioned inwardly of the first holes 264 of a third stepchain link (not shown). The second holes 266 of the inner portions 262 of the third stepchain link (not shown) are positioned outwardly of the first holes 264 of a fourth stepchain link (not shown), and so on.

As shown in FIG. 8B, an attachment member 284 is inserted in the aligned holes 264 of one link and 266 of an adjacent link to secure the inner portions of the links together. The holes 266 are larger than the holes 264, and needle bearings (not shown) are press fit in the holes 266, eliminating the need for lubrication. The attachment member 284 is press fit in the holes 264 of the stepchain links 230b and in the needle bearings in the holes 266 of the stepchain links 230b. The needle bearings rotate around the attachment member 284. A cap 286 and a stepchain roller 288 are attached to the opposing ends of the attachment mechanism 284 after the attachment member 284 is inserted.

As shown in FIGS. 8C through 10, an outer portion 272 is attached to the inner portions of each link. In this example, each outer portion 272 is made up of two pieces, although more or fewer pieces could be used. The outer portion 272 includes a first side 274 and a second side 276 that are on opposite sides of the corresponding inner portion. A bottom surface 278 includes a plurality of teeth 232 having a profile that cooperates with the outer surface 34 of the drive member 36.

When assembled, as shown in FIGS. 8D and 10, the plurality of inner teeth 268 of the inner portions are nestingly received into grooves 271 on an inner side of the bottom surface 287. The outer portions 272 provide an engagement surface for the drive member 36 independently without bearing the tensile loads on the link. The inner portions bear the tensile load.

The inventive arrangement allows for a wide stepchain link 130, 230 and belt 36 interface (shown in FIG. 10) without having an undesirably high link weight. Preferably, the interface between the stepchain links 130, 230 and the belt 36 is 40 mm to 100 mm. Most preferably, the interface is 65 mm. There is also a substantially constant teeth 132 width and pitch across the span between adjacent teeth 132. The inner portions are advantageously heavier gauge steel in one example compared to the outer portions. The inner portions are strong enough to bear the tensile loads while the outer portions 272 provide more surface area for better engagement with the drive member 32. But the outer portions 272 need not carry the tensile loads.

Returning to FIGS. 8C and 8D, the sides 274 and 276 of each outer portion 272 include a plurality of attachment holes 290 that align with the attachment holes 270 of the corresponding inner portions. An attachment member 282 is inserted into the aligned holes 270 and 290 to secure the outer portion 272 to the inner portions. When assembled, the outer portion 272 of one stepchain link 230 does not contact the outer portion 272 of adjacent stepchain link 230. As shown in FIG. 8E, the attachment members 282 are inserted in the aligned attachment holes 270 and 290 and rotated up to 45° to create an interference fit.

FIG. 11 illustrates one of the attachment holes 290. In the illustrated example, each attachment hole 270 and 290 is generally square shaped and at least a portion of the attachment members 282 have a corresponding cross-section. In the illustrated example, the attachment members 282 are inserted in the aligned attachment holes 270 and 290 and rotated up to 45° to create an interference fit. It is to be understood that other shapes of the attachment holes 270 and 290 and attachment members 282 are possible.

Returning to FIG. 8D, an attachment member 282 having an axle 252 is inserted into the aligned holes 270 and 290 closest to the stepchain rollers 288. In one example, the aligned holes 270 and 290 also have a generally square cross-section and the attachment member 282 having the axle 252 has a corresponding cross section. The axle 252 is inserted into the aligned attachment holes 270 and 290 and rotated up to 45° to create an interference fit, securing the axle 252 to the stepchain links 230.

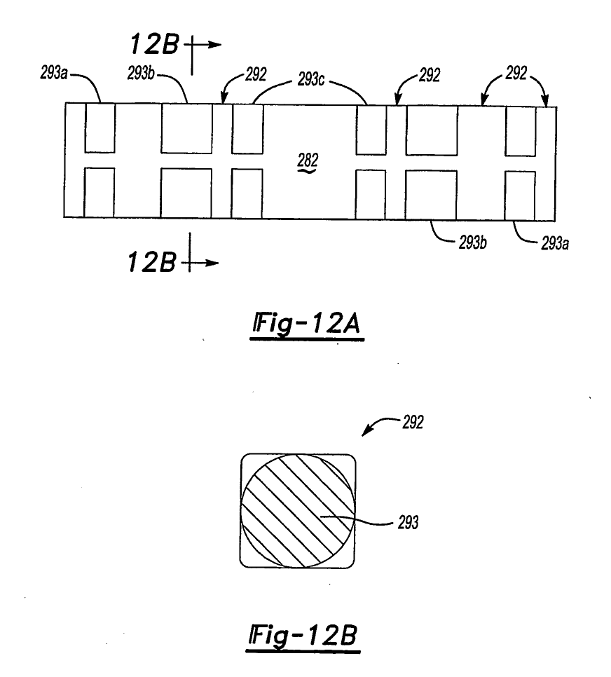

FIG. 12A illustrates a top view of an attachment member 282. FIG. 10 shows the attachment member 282 inserted into the aligned holes 270 and 290 of a stepchain link 230. Each attachment member 282 includes a plurality of flanges 292 that are spaced to receive the link portions between them. In one example, the each flanges 292 extend continually around the outer surface of the attachment member 282. The flanges 292 are positioned on opposite sides of grooves 293 between the flanges 292.

FIG. 12B illustrates an end view of the attachment member 282 of FIG. 12A. As shown, the corners of the grooves 293 are more rounded than the corners of the flanges 292. The attachment members 282 preferably are inserted such that the grooves 293a align with the holes 290 of the outer portion 272, the grooves 293b align with the holes 270 of the outwardly inner portions 262 of the stepchain links 230a, and the grooves 293c align with the holes 270 of the inwardly inner portions 262 of the stepchain links 230b.

When all the parts are properly aligned, the attachment member 282 can be rotated about its axis. The holes 270 and 290 and the outside geometry of the grooves 293 preferably cooperate to provide an interference fit when the attachment member 282 is rotated. The flanges 292 are configured to fit through the holes 270 and 290 during insertion and then to abut corresponding surfaces of the link portions once rotated. The flanges 292 engage the inner portions 262 and the sides 274 and 276 of the outer portion 272 and maintain the desired lateral spacing between the link portions.

As seen in FIG. 8D, a bridge support 280 attached to the inner portion provides a support for the bridge 49 during operation of the conveyor system 20 similar to the bridge support 180 of FIG. 4. The bridge support 280 is preferably attached to an inner portion by welding, pins, or the like.

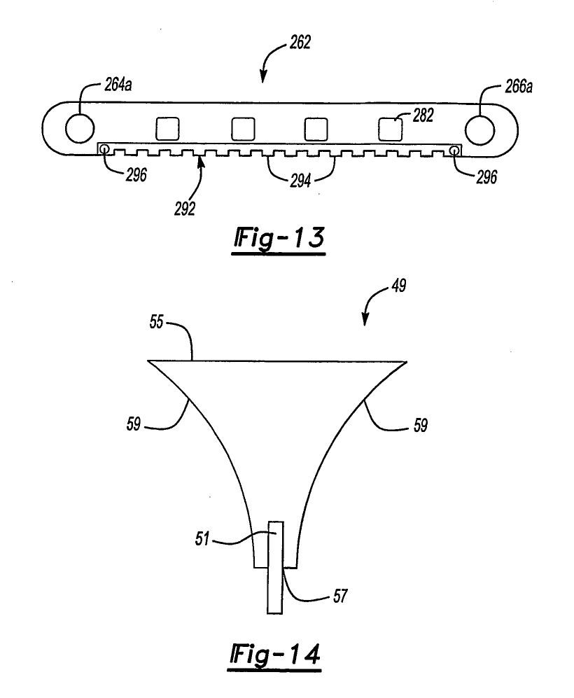

Another example link configuration is shown in FIG. 13. An injection molded plate 292 having teeth 294 is snapped on the inner portions 262 and secured by an attachment member 296. The attachment member 296 can be a screw, pin, or another known fastener. The plate 292 provides a non-metallic drive member engagement surface on the links. By employing the plate 292 of injection molded teeth 294, corrosion is reduced.

Although multiple inner portions are used with each link in the illustrated example, one inner portion may be used. Similarly, more than two inner portions may be provided for each link.

The stepchain links 130 and 230 of the present invention carry the loads of the steps 24 and transfer the load from the drive member 36 to the plurality of stepchain links 130 and 230 through the plurality of teeth 132 and 232. Therefore, the stepchain links 130 and 230 carry the load of the passenger conveyor system 20.

The outer portions are may take a variety of forms, depending on the selected method of securing the inner an outer portions together. Those skilled in the art who have the benefit of this description will be able to select the best component design to met their particular needs.

There are several benefits to the stepchain links of the present invention. The teeth 32 are made of a single integrated piece of material. As the width of the stepchain links is greater than the prior art, there is greater surface area contact and better interaction between the stepchain links and the drive member. The polyurethane belt and the bearings reduce the need for lubrication. The stepchain links of the present invention prevent twisting under the eccentric load and prevent buckling while under compression. Additionally, the diecast stepchain links are light in weight and low in cost. As the die cast part is formed of one piece, there is no assembly tolerance stack up as there is with the prior art stacked laminated sheets and the number of parts are reduced. The material of the sheet stepchain links is insensitive to defects, and there are no thermal expansion issues between the attachment members and the stepchain links.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

We claim:

1. A drive assembly for a passenger conveyor system comprising:
a drive member; and
a plurality of metal stepchain links each having a plurality of teeth made of an integrated piece of material that engages a corresponding surface on said drive member.

2. The assembly as recited in claim 1 wherein each of said plurality of teeth of said plurality of stepchain links have a substantially constant teeth width which is substantially constant across a span between adjacent teeth.

3. The assembly as recited in claim 1 wherein said plurality of teeth of said plurality of stepchain links continually engage said drive member.

4. The assembly as recited in claim 1 wherein said plurality of teeth of said plurality of stepchain links have a substantially constant pitch which is substantially constant across a span between adjacent teeth.

5. The assembly as recited in claim 1 wherein said drive member comprises a non-metallic portion and a metallic portion.

6. The assembly as recited in claim 1 wherein each said stepchain link comprises a single piece of die cast metal.

7. The assembly as recited in claim 6 wherein said die cast metal is selected from the group consisting of aluminum and magnesium.

8. The assembly as recited in claim 7 wherein each of said stepchain links includes a first end having a hole and a second end having two spaced apart portions, each including a hole, said first end of one of said stepchain links is received at least partially between said second end portions of another of said plurality of stepchain links, and including an attachment member received through said holes to secure said first end of said one stepchain links to said second end of said another stepchain link.

9. The assembly as recited in claim 7 wherein a first of said stepchain links includes a first end having a first hole and a second end having a second hole and a second of said stepchain links includes a third end having two spaced apart portions each including a third spaced apart hole and a fourth end having two spaced apart portions each including a fourth spaced apart hole, and each of said first end and said second end of said first of said stepchain links is received at least partially between one of said third end having two spaced apart portions and said fourth end having two spaced apart portions, and including an attachment member received through said holes to secure said first end and said second end of said one stepchain links to one of said third end and said fourth end of said another stepchain links.

10. The assembly as recited in claim 1 wherein each said stepchain link comprises at least one piece of sheet metal.

11. The assembly as recited in claim 10 wherein said stepchain links each include an outer drive member engaging portion having a first side and a second side and a bottom extending therebetween, said bottom having at least some of said plurality of teeth, and said sheet metal piece is secured to said outer portion such that said sheet metal piece carries tensile loads on said links.

12. The assembly as recited in claim 11 wherein a distance between said at least one piece of sheet metal is smaller than a width of said bottom of said stepchain links.

13. The assembly as recited in claim 11 wherein each stepchain link includes at least two sheet metal pieces secured to said outer portion, said sheet metal pieces of one of said stepchain links secured to said sheet metal pieces of an adjacent stepchain link, said outer portions of adjacent links not contacting each other.

14. The assembly as recited in claim 11 wherein said sheet metal piece include lateral openings and said first and said second sides of said outer portion include corresponding openings and including an attachment member received through said openings to secure said outer portion to said sheet metal pieces.

15. The assembly as recited in claim 11 wherein a plate having a plurality of plastic teeth are secured on said bottom having some of said plurality of teeth.

16. The assembly as recited in claim 1 wherein an interface between said drive member and said plurality of metal stepchain links is between 40 mm and 100 mm.

17. The assembly as recited in claim 16 wherein an interface between said drive member and said plurality of metal stepchain links is 65 mm.

18. A passenger conveyor system comprising:
a plurality of steps moveable in a loop along a path;
at least one panel member adjacent each step;
a drive member; and
a plurality of metal stepchain links each having a plurality of teeth made of an integrated piece of material that engages a corresponding surface on said drive member.

19. The system as recited in claim 18 wherein each of said plurality of teeth of said plurality of stepchain links have a substantially constant teeth width which is substantially constant across a span between adjacent teeth.

20. The system as recited in claim 18 wherein said plurality of teeth of said plurality of stepchain links continually engage said drive member.

21. The system as recited in claim 18 wherein said plurality of teeth of said plurality of stepchain links have a substantially constant pitch which is substantially constant across a span between adjacent teeth.

22. The system as recited in claim 21 wherein said drive member comprises a non-metallic portion and a metallic portion.

23. The system as recited in claim 21 wherein each of said plurality of stepchain links includes a support that at least partially supports a bridge positioned between said at least one panel members of adjacent steps.

24. The system as recited in claim 18 wherein said stepchain links are formed of die cast metal.

25. The system as recited in claim 24 wherein said die cast metal is selected from the group consisting of aluminum and magnesium.

26. The system as recited in claim 18 wherein each said stepchain link comprises at least one piece of sheet metal.

27. The system as recited in claim 26 wherein said stepchain links each includes an outer drive member engaging portion having a first side and a second side and a bottom extending therebetween, said bottom having at least some of said plurality of teeth, and said sheet metal piece is secured to said outer portion such that said sheet metal piece carries tensile loads on said links.

28. The system as recited in claim 26 wherein a distance between said at least one piece of sheet metal is smaller than a width of said bottom of said stepchain links.

29. The system as recited in claim 26 wherein each stepchain link includes at least two sheet metal pieces secured to said outer portion, said sheet metal pieces of one of said stepchain links secured to said sheet metal pieces of an adjacent stepchain link, said outer portions of adjacent links not contacting each other.

30. The system as recited in claim 26 wherein a plate having a plurality of plastic teeth are secured on said bottom having some of said plurality of teeth.

31. The system as recited in claim 18 wherein an interface between said drive member and said plurality of metal stepchain links is between 40 mm and 100 mm.

32. The system as recited in claim 31 wherein an interface between said drive member and said plurality of metal stepchain links is 65 mm.

33. A stepchain link for a passenger conveyor system comprising:
a body portion of a single piece of metal each; and
a plurality of teeth made of an integrated piece of material that engage a corresponding surface on a drive member.

34. A stepchain link for a passenger conveyor system comprising:
a first portion adapted to carry tensile loads on the link; and
a second portion adapted to engage a drive member, said second portion not carrying said tensile loads.
